(19) United States
(12) Patent Application Publication
(10) Pub. No.: US 2026/0140298 A1
(43) Pub. Date: May 21, 2026

(54) LIGHT-EMITTING MEMBER AND DISPLAY DEVICE INCLUDING SAME

(71) Applicant: MEMSLUX, Daejeon (KR)

(72) Inventors: Jeongmu LEE, Daejeon (KR); Ho Won LEE, Daejeon (KR); Suhyeon KIM, Daejeon (KR)

(73) Assignee: MEMSLUX, Daejeon (KR)

(21) Appl. No.: 19/392,328

(22) Filed: Nov. 18, 2025

(30) Foreign Application Priority Data
Nov. 19, 2024 (KR) 10-2024-0165587

(51) Int. Cl. F21V 8/00; G02B 5/02

(52) U.S. Cl. CPC G02B 6/0036; G02B 5/0215; G02B 6/0055

(57) ABSTRACT

The present disclosure relates to a light-emitting member improving vertical light-emitting characteristics and a display device including same. According to an embodiment, a light-emitting member includes: one surface on which light-emitting patterns are formed; and the other surface through which light reflected and/or refracted by light-emitting patterns is emitted, in which each of the light-emitting patterns is a concave pattern corresponding to a portion of a cone having a bottom surface and a predetermined depth, the bottom surface of the light-emitting pattern has a fan shape, a cross-section of the light-emitting pattern has a right triangular shape, the cross-section is a surface obtained by cutting the light-emitting pattern perpendicularly to the one surface along a line passing through a center of the bottom surface, and an arc portion of the bottom surface of the light-emitting pattern is disposed to face the one side surface.

### CROSS-REFERENCE TO RELATED APPLICATIONS

The present application claims priority under 35 U.S.C. § 119 of Korean Patent Application No. 10-2024-0165587, filed November 19, 2024, the entire contents of which are hereby incorporated by reference.

### BACKGROUND

The present disclosure relates to a light-emitting member and a display device including the same, and more particularly, to a light-emitting member capable of improving vertical light-emitting characteristics and a display device including the same.

FIG. 1 is a view for explaining a conventional light-emitting member.

Referring to FIG. 1, a plurality of light-emitting patterns 15 each having a concave shape are formed on one surface of a conventional light-emitting member 10. The light-emitting pattern 15 has a cross-section shape of a pillar or trench.

When an adhesive protection film is laminated onto one surface (patterned surface) of the light-emitting member 10 to protect the plurality of light-emitting patterns 15 of the light-emitting member 10 by using the adhesive protection film, an adhesive layer 20, which is soft like foam, of the adhesive protection film may be filled into the concave pattern to embed the pattern due to a cross-sectional structure of the light-emitting pattern 15,

In this case, as a portion of the light-emitting pattern 15 is embedded by the adhesive layer 20, a size of the light-emitting pattern 15 may be reduced or all of the light-emitting pattern 15 may be embedded by the adhesive layer 20.

As illustrated in FIG. 2, when a portion or all of the light-emitting pattern 15 is embedded by the adhesive layer 20 in the case that the adhesive layer 20 has a refractive index equal or similar to that of the light-emitting member 10, a difference between refractive indices between the light-emitting member 10 and the adhesive layer 20 is substantially removed, and thus a total reflection effect, which occurs at an interface due to a large difference between media, disappears. Accordingly, the light-emitting pattern 15 may not extract light.

Conventionally, some of the light-emitting patterns have an inclined surface, which disturbs a light-emitting angle of the light-emitting member from being formed primarily in a vertical direction when the concave pattern has a flat bottom surface instead of a sharp bottom surface.

Also, when a shape of the light-emitting pattern on a top view is deviated from an arc or elliptical arc shape, incident light caused by the arrangement and light-emitting angle of the light source may not be sufficiently mixed in various directions, thereby causing a so-called 'searchlight phenomenon (bright-line phenomenon)'.

### SUMMARY

The present disclosure provides a light-emitting member capable of improving vertical light-emitting characteristics and a display device including the same.

The present disclosure also provides a light-emitting member capable of improving a searchlight phenomenon and a display device including the same.

The present disclosure also provides a light-emitting member in which an adhesive layer of a protection film is not embedded into the light-emitting pattern and a display device including the same.

An embodiment of the present disclosure provides a light-emitting member including: one side surface; one surface on which a plurality of light-emitting patterns are formed; and the other surface through which light reflected and/or refracted by the plurality of light-emitting patterns is emitted, in which each of the light-emitting patterns is a concave pattern corresponding to a portion of a cone having a bottom surface and a predetermined depth, the bottom surface of the light-emitting pattern has a fan shape, the bottom surface of the light-emitting pattern has a central angle equal to or greater than 90° and less than 360°, a cross-section of the light-emitting pattern has a right triangular shape, the cross-section is a surface obtained by cutting the light-emitting pattern perpendicularly to the one surface along a line passing through a center of the bottom surface, and an arc portion of the bottom surface of the light-emitting pattern is disposed to face the one side surface.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a view for explaining a conventional light-emitting member;

FIG. 2 is a view for explaining a reason why light is not emitted when an adhesive layer is embedded in a light-emitting pattern;

FIG. 3 is a plan view illustrating a light-emitting member 100 according to an embodiment of the present disclosure;

FIG. 4 is a cross-sectional view taken along line A-A' of FIG. 3;

FIG. 5 is a view for explaining a perspective view, a bottom surface shape, and a cross-sectional shape of only a light-emitting pattern 150 in FIGS. 3 and 4;

FIGS. 6 to 9 are views for explaining perspective views, bottom surface shapes, and cross-sectional shapes of various modified examples of the light-emitting pattern 150 in FIG. 5;

FIG. 10 is a view illustrating a comparison between a total flux and maximum luminance emitted from a display device having light-emitting patterns 150, 150', 150'', 150''', and 150'''' illustrated in FIGS. 5 to 9;

FIG. 11 is a plan view illustrating a light-emitting member 200 according to another embodiment of the present disclosure;

FIG. 12 is a cross-sectional view taken along line B-B' of FIG. 11;

FIG. 13 is a view for explaining a perspective view, a bottom surface shape, and a cross-sectional shape of only a light-emitting pattern 250 illustrated in FIGS. 11 and 12;

FIGS. 14 and 15 are views for explaining perspective views, bottom surface shapes, and cross-sectional shapes of various modified examples of the light-emitting pattern 250 illustrated in FIG. 13;

FIG. 16A is a photograph of light emitted from an light-emitting surface when light is incident to incidence surfaces of the light-emitting members 100 and 200 having the light-emitting patterns 150, 150', 150'', 150''', and 150'''' illustrated in FIGS. 5 to 9 and the light-emitting patterns 250, 250', and 250'' illustrated in FIGS. 13 to 15, and FIG. 16B is a photograph of light emitted from the light-emitting surface of the conventional light-emitting member;

FIG. 17A is a cross-sectional view illustrating a display device including the light-emitting member 100 illustrated in FIG. 4, and FIG. 17B is a cross-sectional view illustrating a display device including the light-emitting member 200 illustrated in FIG. 12;

FIGS. 18A and 18B are views for explaining a light-emitting member according to another embodiment of the present disclosure;

FIG. 19A is a cross-sectional view illustrating a display device including a light-emitting member 300 illustrated in FIG. 18A, and FIG. 19B is a cross-sectional view illustrating a display device including a light-emitting member 400 illustrated in FIG. 18B;

FIG. 20 is a radiance distribution view of the display device (without a protection film) of FIG. 17A and the display device (with a protection film) of FIG. 19A;

FIG. 21 is a radiance distribution view of the display device (without a protection film) of FIG. 17B and the display device (with a protection film) of FIG. 19B;

FIG. 22 is a cross-sectional view illustrating a light-emitting member 900 according to another embodiment of the present disclosure;

FIG. 23 is a view for explaining a perspective view, a bottom surface shape, and a cross-sectional shape of only a light-emitting pattern 950 illustrated in FIG. 22;

FIG. 24 is a radiance distribution view of a display device having a light-emitting member 900 illustrated in FIGS. 22 and 23; and

FIG. 25 is a view for explaining a perspective view and a bottom surface shape of a modified example of the light-emitting pattern 950 illustrated in FIG. 23.

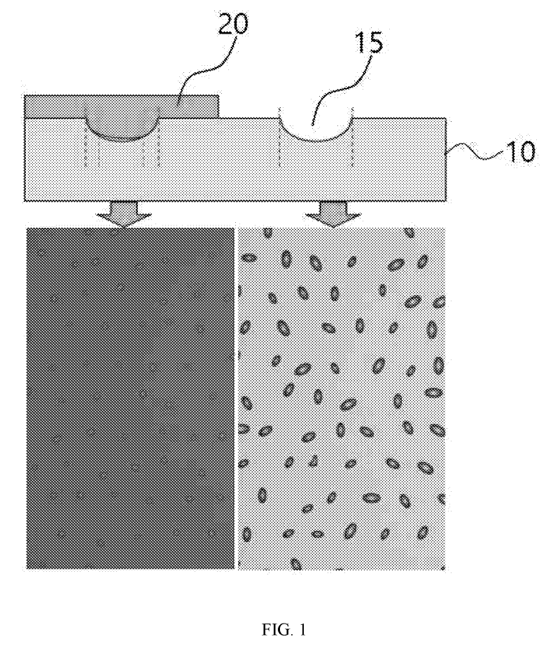

### DETAILED DESCRIPTION

Hereinafter, preferred embodiments of the present disclosure will be described in detail with reference to the accompanying drawings. It will be understood that the same reference numerals designate the same components throughout the drawings. For reference, detailed descriptions related to well-known functions or configurations will be ruled out in order not to unnecessarily obscure subject matters of the present disclosure.

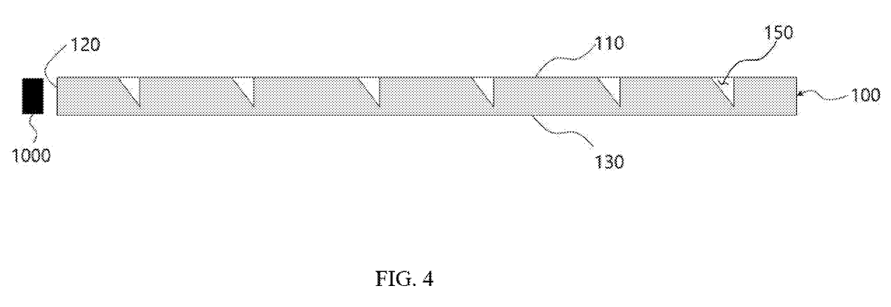

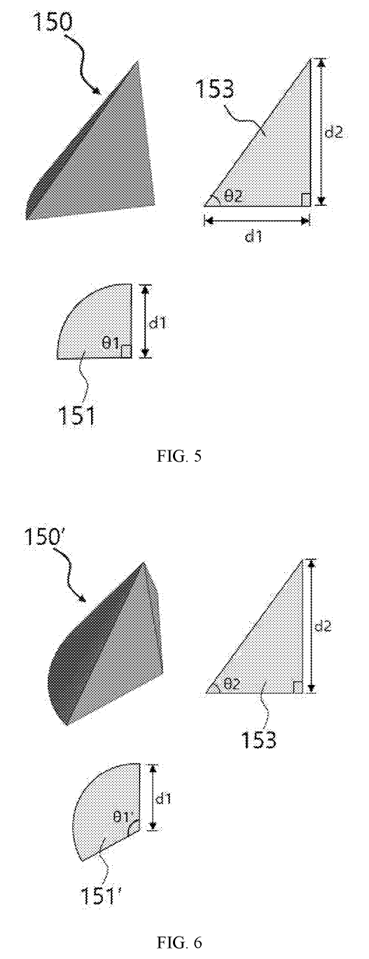

FIG. 3 is a plan view illustrating a light-emitting member 100 according to an embodiment of the present disclosure, FIG. 4 is a cross-sectional view taken along line A-A' of FIG. 3, and FIG. 5 is a perspective view illustrating only a light-emitting pattern 150 illustrated in FIGS. 3 and 4, and is a view for explaining a bottom surface shape and a cross-sectional shape thereof.

Referring to FIGS. 3 to 5, the light-emitting member 100 according to an embodiment of the present disclosure has a plate shape having a predetermined thickness.

The light-emitting member 100 may be made of a light-transmissive material.

The light-emitting member 100 may be made of a rigid material or a flexible material. For example, the light-emitting member 100 may be made of a resin or PMMA.

The light-emitting member 100 has one surface 110 (or a patterned surface). A plurality of light-emitting patterns 150 are defined in one surface 110.

The plurality of light-emitting patterns 150 may be arranged regularly or randomly.

The light-emitting member 100 has the other surface 130 (or a light-emitting surface). Light reflected or refracted by the light-emitting pattern 150 is emitted to the outside through the other surface 130.

The light-emitting member 100 has a plurality of side surfaces disposed between the one surface 110 and the other surface 130. One side surface 120 of the plurality of side surfaces may serve as an incident surface to which light emitted from a light source 1000 is incident.

The light-emitting pattern 150 is a concave pattern. The light-emitting pattern 150 may also be referred to as a cavity. The light-emitting pattern 150 may have a shape corresponding to a portion of a cone.

A bottom surface 151 of the light-emitting pattern 150 has a fan shape. An arc portion in the bottom surface 151 having the fan shape is disposed to face the one side surface 120. Since the arc portion is disposed to face the one side surface 120, there is an advantage in that a searchlight phenomenon (bright-line phenomenon) does not occur in the other surface 130 that is a light-emitting surface. Here, the bottom surface 151 is disposed on the same plane as the one surface 110.

The fan-shaped bottom surface 151 may have a central angle θ1 of 90°.

The light-emitting pattern 150 has a cross-section 153 of a right triangle. Here, the cross-section 153 is obtained by cutting the light-emitting pattern 150 perpendicularly to the one surface 110 along a line passing through a center of the fan-shaped bottom surface 151.

The cross-section 153 having the right triangular shape may have an inclination angle θ2 equal to or greater than 50° and equal to or less than 60°. Preferably, the inclination angle θ2 may be equal to or greater than 52° and equal to or less than 56°. More preferably, the inclination angle θ2 may be 54°.

The fan-shaped bottom surface 151 may have a radius d1 less than a height d2 of the right-triangular cross-section 153. Here, the height d2 may also be referred to as a depth of the light-emitting pattern 150.

FIGS. 6 to 9 are views for explaining perspective views, bottom surface shapes, and cross-sectional shapes of various modified examples of the light-emitting pattern 150 illustrated in FIG. 5.

A light-emitting pattern 150' in FIG. 6 is different from the light-emitting pattern 150 in FIG. 5 in terms of a central angle θ1' of a fan-shaped bottom surface 151'. The central angle θ1' is 120°.

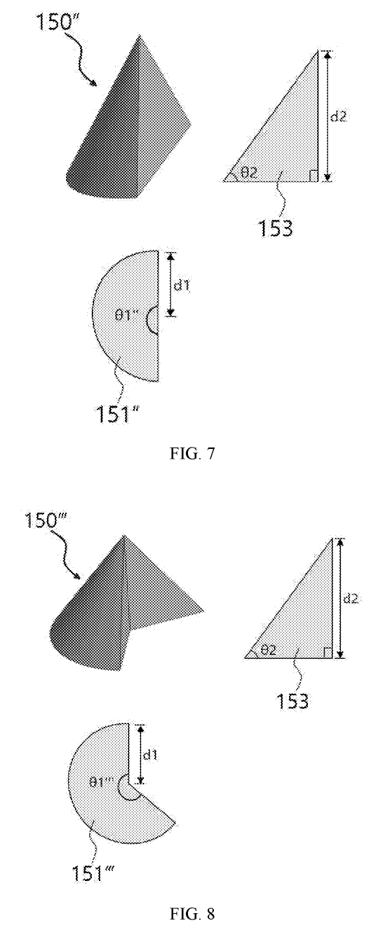

A light-emitting pattern 150'' in FIG. 7 is different from the light-emitting pattern 150 in FIG. 5 in terms of a central angle θ1'' of a fan-shaped bottom surface 151''. The central angle θ1'' is 180°.

A light-emitting pattern 150''' in FIG. 8 is different from the light-emitting pattern 150 in FIG. 5 in terms of a central angle θ1''' of a fan-shaped bottom surface 151'''. The central angle θ1''' is 240°.

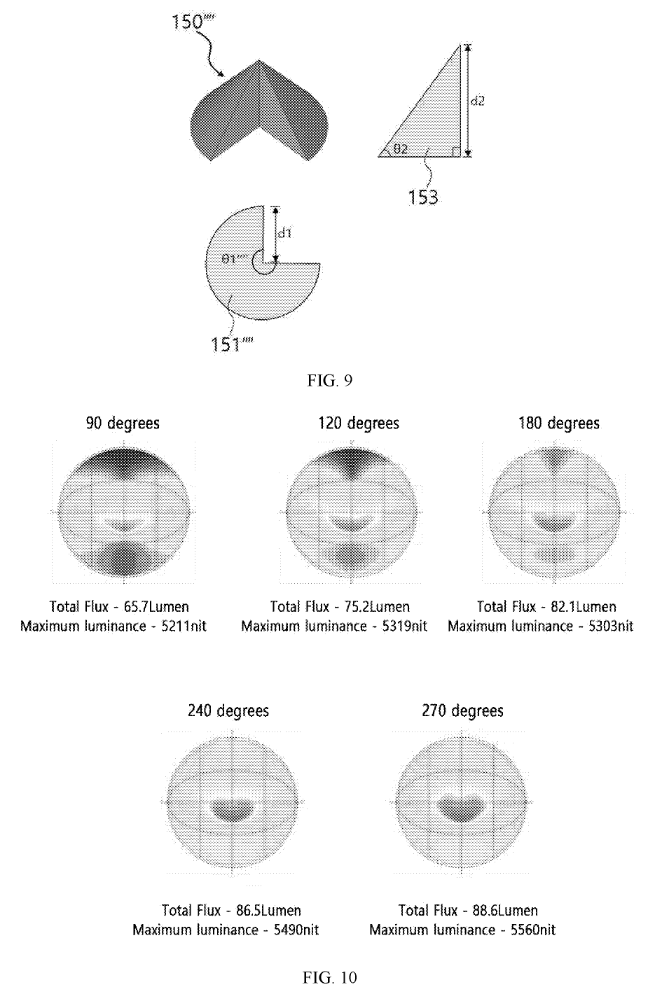

A light-emitting pattern 150'''' in FIG. 9 is different from the light-emitting pattern 150 in FIG. 5 in terms of a central angle θ1'''' of a fan-shaped bottom surface 151''''. The central angle θ1'''' is 270°.

The central angle of the bottom surface of the light-emitting pattern according to an embodiment of the present disclosure including the light-emitting patterns 150, 150', 150'', 150''', and 150'''' in FIGS. 5 to 9 may be equal to or greater than 90° and less than 360°. Here, the central angle of the bottom surface may be equal to or greater than 90° and less than 180°, or greater than 180° and less than 360°. When the central angle of the bottom surface is less than 90°, it may be disadvantageous in terms of removing the searchlight phenomenon.

FIG. 10 is a view illustrating a comparison between a total flux and maximum luminance emitted from a display device having the light-emitting patterns 150, 150', 150'', 150''', and 150'''' illustrated in FIGS. 5 to 9.

Referring to FIG. 10, it may be known that most of light is efficiently converged toward a vertical center and emitted (vertically emitted) when using the light-emitting member having the light-emitting patterns 150, 150', 150'', 150''', and 150'''' illustrated in FIGS. 5 to 9. Accordingly, when only the light-emitting member having the light-emitting patterns 150, 150', 150'', 150''', and 150'''' illustrated in FIGS. 5 to 9 is applied in a state in which all of a diffusion sheet and two prism sheets of a conventional backlight unit are removed, there is an advantage in that the substantially same light as the vertically emitted light generated by the conventional backlight unit may be obtained. Also, since all of the diffusion sheet and the two prism sheets used in the conventional backlight unit may be removed, there is an advantage in that the display device may have a relatively thin thickness.

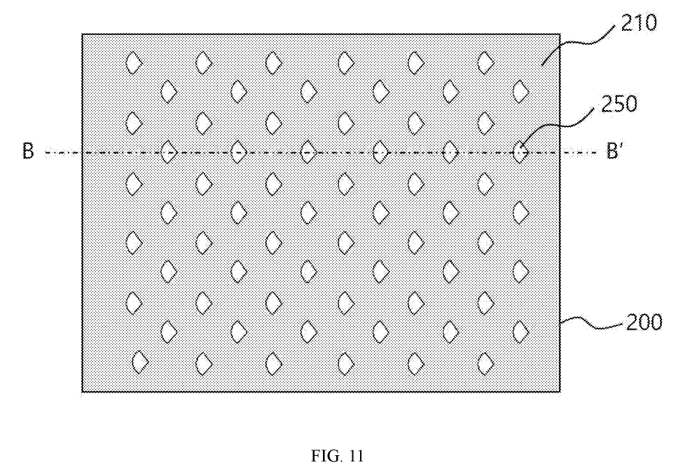

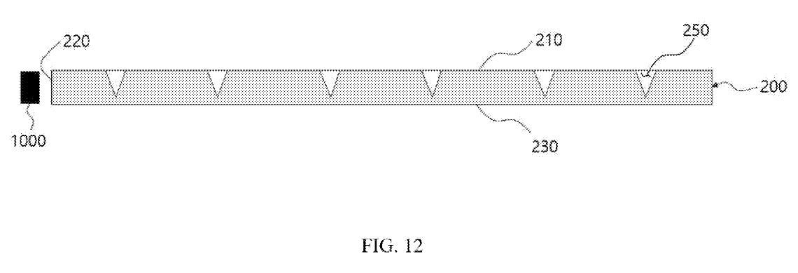

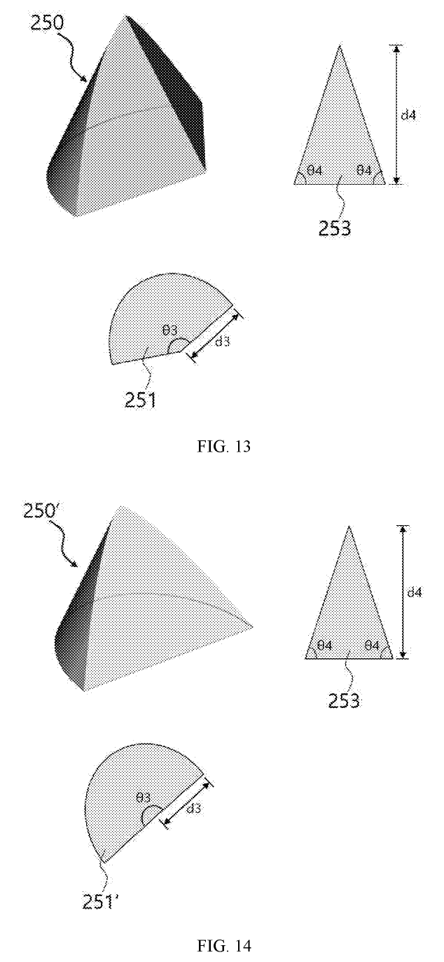

FIG. 11 is a plan view of a light-emitting member 200 according to another embodiment of the present disclosure, FIG. 12 is a cross-sectional view taken along line B-B' of FIG. 11, and FIG. 13 is a view for explaining a perspective view, a bottom surface shape, and a cross-sectional shape of only a light-emitting pattern 250 illustrated in FIGS. 11 and 12.

Referring to FIGS. 11 to 13, the light-emitting member 200 according to another embodiment of the present disclosure has a plate shape having a predetermined thickness.

The light-emitting member 200 may be made of a light-transmissive material.

The light-emitting member 200 may be made of a rigid material or a flexible material. For example, the light-emitting member 200 may be made of a resin or PMMA.

The light-emitting member 200 has one surface 210 (or a patterned surface). A plurality of light-emitting patterns 250 are defined in the one surface 210.

The plurality of light-emitting patterns 250 may be arranged regularly or randomly.

The light-emitting member 200 has the other surface 230 (or a light-emitting surface). Light reflected by the light-emitting patterns 250 is emitted to the outside through the other surface 230.

The light-emitting member 200 has a plurality of side surfaces disposed between the one surface 210 and the other surface 230. One side surface 220 of the plurality of side surfaces serves as an incidence surface to which light emitted from a light source 1000 is incident.

The light-emitting pattern 250 is a concave pattern. The light-emitting pattern 250 may also be referred to as a cavity. The light-emitting pattern 250 may have a shape corresponding to a portion of a cone.

A bottom surface 251 of the light-emitting patterns 250 has a fan shape. An arc portion in the bottom surface 251 having the fan shape is disposed to face the one side surface 220. Since the arc portion is disposed to face the one side surface 220, there is an advantage in that a searchlight phenomenon (bright-line phenomenon) does not occur at the other surface 230 that is the light-emitting surface when light is incident to the one side surface 220. Here, the bottom surface 251 is disposed on the same plane as the one surface 210.

The fan-shaped bottom surface 251 may have a central angle θ3 equal to or greater than 90° and less than 360°. Here, the fan-shaped bottom surface 251 may have the central angle θ3 equal to or greater than 90° and less than 180° or the central angle θ3 greater than 180° and less than 360°.

The light-emitting pattern 250 has a cross-section 253 of an isosceles triangle. Here, the cross-section 253 is obtained by cutting the light-emitting pattern 250 perpendicularly to the one surface 210 along a line passing through a center of the fan-shaped bottom surface 251.

The isosceles triangular cross-section 253 may have an inclination angle θ4 equal to or greater than 50° and equal to or less than 60°. Preferably, the inclination angle θ4 may be equal to or greater than 52° and equal to or less than 56°. More preferably, the inclination angle θ4 may be 54°.

The fan-shaped bottom surface 251 may have a radius d3 less than a height d4 of the isosceles triangular cross-section 253. The height d4 may also be referred to as a depth of the light-emitting pattern 250.

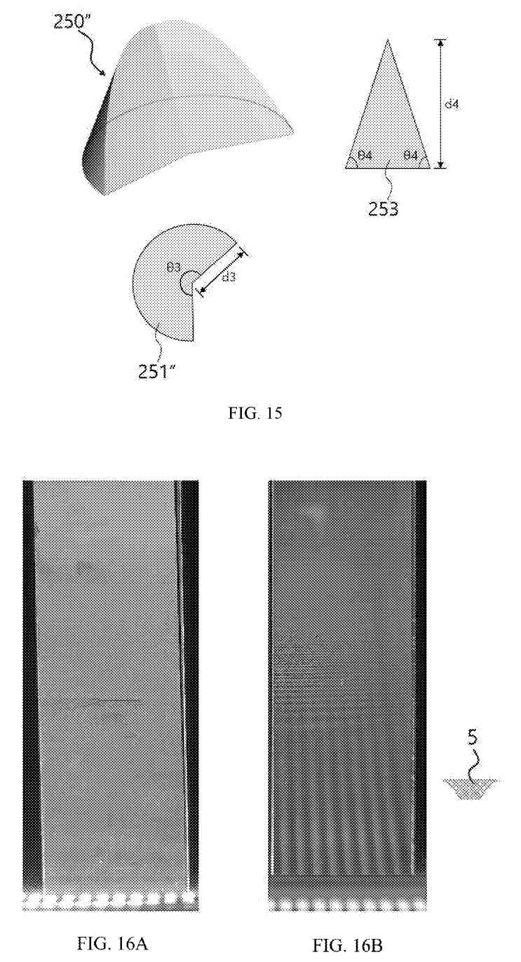

FIGS. 14 and 15 are views for explaining perspective views, bottom surface shapes, and cross-sectional shapes of various modified examples of the light-emitting pattern 250 illustrated in FIG. 13.

A light-emitting pattern 250' in FIG. 14 is different from the light-emitting pattern 250 in FIG. 13 in terms of a central angle θ3' of a fan-shaped bottom surface 251'. The central angle θ3' is 180°.

A light-emitting pattern 250'' in FIG. 15 is different from the light-emitting pattern 250 in FIG. 13 in terms of a central angle θ3'' of a fan-shaped bottom surface 251''. The central angle θ3'' is 240 °.

FIG. 16A is a photograph of light emitted from an light-emitting surface when light is incident to the incidence surfaces of the light-emitting members 100 and 200 having the light-emitting patterns 150, 150', 150'', 150''', and 150'''' illustrated in FIGS. 5 to 9 and the light-emitting patterns 250, 250', and 250'' illustrated in FIGS. 13 to 15, and FIG. 16B is a photograph of light emitted from the light-emitting surface of the conventional light-emitting member. Here, the light-emitting pattern of the conventional light-emitting member in FIG. 16B is a concave pattern having a trapezoidal bottom surface 5.

Referring to FIG. 16B, since the bottom surface 5 of the light-emitting pattern of the conventional light-emitting member has a trapezoidal shape in which a portion facing the incidence surface has a straight line shape, a searchlight phenomenon occurs at the light-emitting surface which emits bright light in a straight line unlike other portions. However, as illustrated in FIG. 16A, since the light-emitting members 100 and 200 according to an embodiment of the present disclosure have an advantage in that a portion disposed toward the incidence surface of the bottom surface of the light-emitting pattern has a circular shape, the searchlight phenomenon does not occur at the light-emitting surface in FIG. 16B.

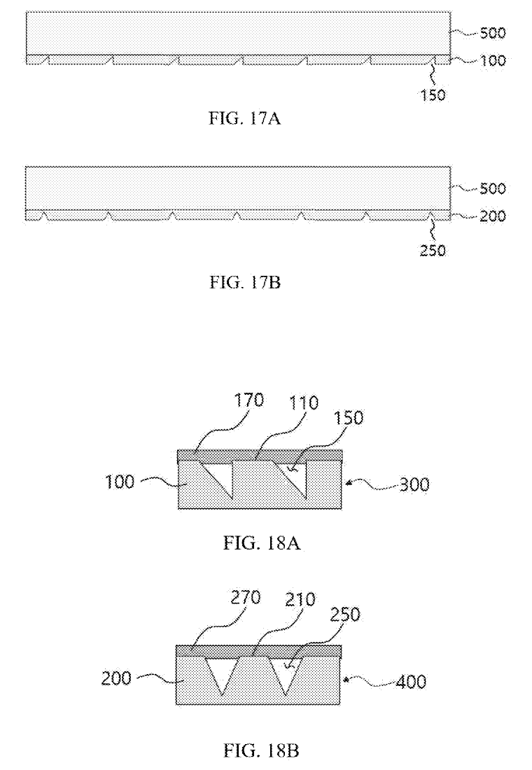

FIG. 17A is a cross-sectional view illustrating a display device including the light-emitting member 100 illustrated in FIG. 4, and FIG. 17B is a cross-sectional view illustrating a display device including the light-emitting member 200 illustrated in FIG. 12.

Referring to FIG. 17A, a display device according to an embodiment of the present disclosure may include a light-emitting member 100 having a plurality of light-emitting patterns 150, and a light guide member 500 disposed on the light-emitting member 100. Although not shown, a reflection member may be further disposed below the light-emitting member 100, and at least one light source that provides light to one side surface of the light guide member 500 and/or at one side surface of the light-emitting member 100 may be further disposed.

Referring to FIG. 17B, a display device according to another embodiment of the present disclosure may include a light-emitting member 200 having a plurality of light-emitting patterns 250, and a light guide member 500 disposed on the light-emitting member 200. Although not shown, a reflection member may be further disposed below the light-emitting member 200, and at least one light source that provides light to one side surface of the light guide member 500 and/or at one side surface of the light-emitting member 200 may be further disposed.

FIGS. 18A and 18B are views for explaining a light-emitting member according to another embodiment of the present disclosure.

A light-emitting member 300 in FIG. 18A further includes an adhesive layer 170 disposed on one surface 110 of the light-emitting member 100 illustrated in FIG. 4.

The adhesive layer 170, which is a layer obtained by applying an adhesive material on one surface of a protection film (not shown), may be one component of the protection film (not shown). The protection film (not shown) may be laminated onto the one surface 110 of the light-emitting member 100 through the adhesive layer 170.

As described above with reference to FIG. 5, since the radius d1 of the bottom surface 151 of the light-emitting pattern 150 is less than the height d2 of the cross-section 153 of the light-emitting pattern 150, it is difficult for the adhesive layer 170 to be embedded into the light-emitting pattern 150.

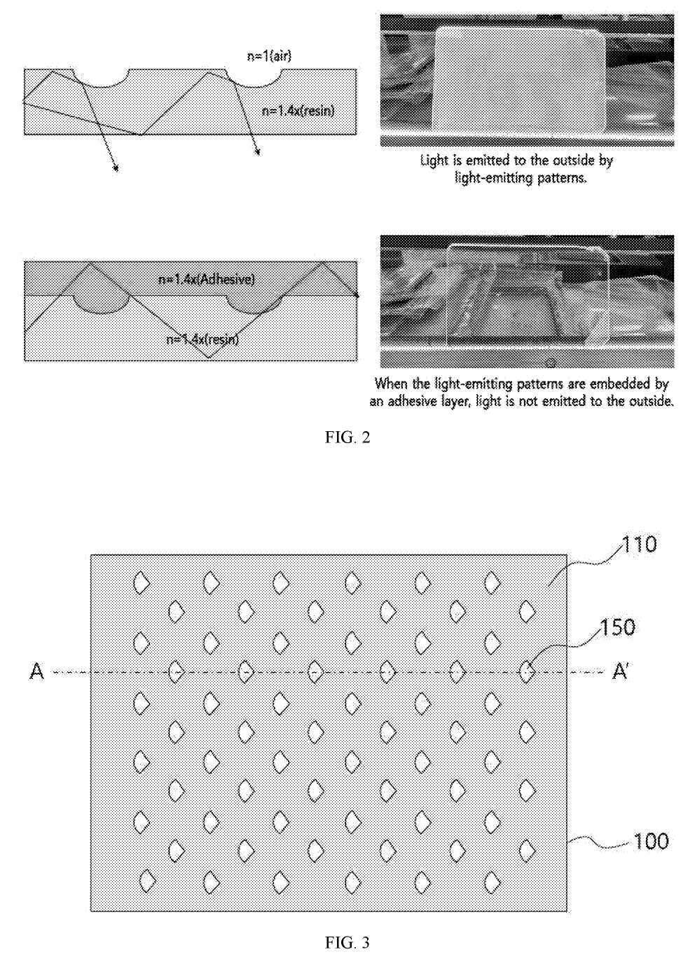

Thus, as described above with reference to FIG. 2, the conventional problem in which the adhesive layer is embedded into the light-emitting pattern to prevent light from being emitted from the light-emitting surface may be solved.

A light-emitting member 400 in FIG. 18B further includes an adhesive layer 270 disposed on the one surface 210 of the light-emitting member 200 illustrated in FIG. 12.

The adhesive layer 270, which is a layer obtained by applying an adhesive material on one surface of a protection film (not shown), may be one component of the protection film (not shown). The protection film (not shown) may be laminated onto the one surface 210 of the light-emitting member 200 through the adhesive layer 270.

As described above with reference to FIG. 13, since the radius d3 of the bottom surface 251 of the light-emitting pattern 250 is less than the height d4 of the cross-section 253 of the light-emitting pattern 250, it is difficult for the adhesive layer 270 to be embedded into the light-emitting pattern 250. Thus, as described above with reference to FIG. 2, the conventional problem in which the adhesive layer is embedded into the light-emitting pattern to prevent light from being emitted from the light-emitting surface may be solved.

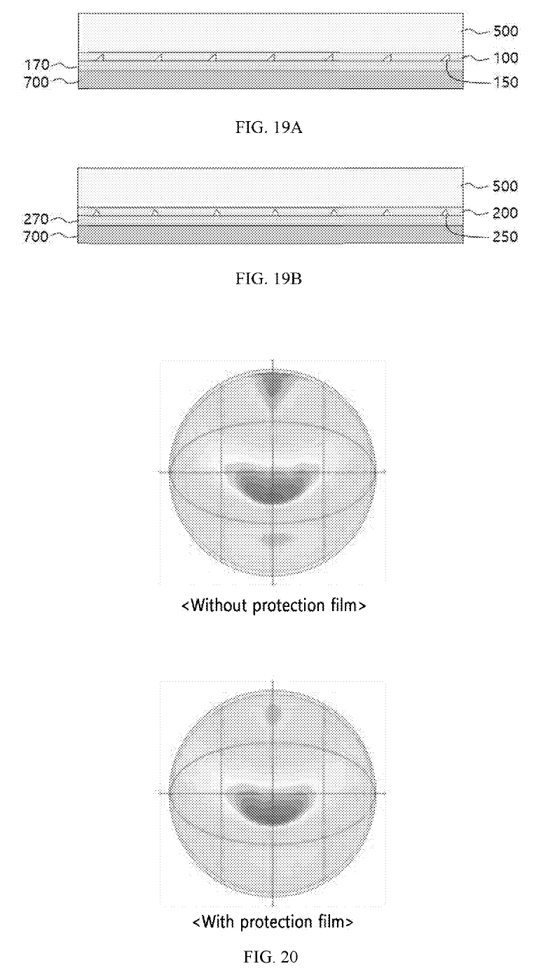

FIG. 19A is a cross-sectional view illustrating a display device including the light-emitting member 300 illustrated in FIG. 18A, and FIG. 19B is a cross-sectional view illustrating a display device including the light-emitting member 400 illustrated in FIG. 18B.

Referring to FIG. 19A, a display device according to another embodiment of the present disclosure may include: a light-emitting member 100 having a plurality of light-emitting patterns 150; a light guide member 500 disposed on the light-emitting member 100; an adhesive layer 170 disposed below the light-emitting member 100; and a protection film 700 disposed below the adhesive layer 170. Here, the adhesive layer 170 may be one component of the protection film 700. Although not shown, a reflection member may be further disposed below the protection film 700, and at least one light source that provides light to one side surface of the light guide member 500 and/or one side surface of the light-emitting member 100 may be further disposed.

Referring to FIG. 19B, a display device according to another embodiment of the present disclosure may include: a light-emitting member 200 having a plurality of light-emitting patterns 250; a light guide member 500 disposed on the light-emitting member 200; an adhesive layer 270 disposed below the light-emitting member 200; and a protection film 700 disposed below the adhesive layer 270. Here, the adhesive layer 270 may be one component of the protection film 700. Although not shown, a reflection member may be further disposed below the protection film 700, and at least one light source that provides light to one side surface of the light guide member 500 and/or one side surface of the light-emitting member 200 may be further disposed.

FIG. 20 is a radiance distribution view of the display device (without the protection film) of FIG. 17A and the display device (with the protection film) of FIG. 19A.

Referring to FIG. 20, it may be known that there is almost no difference between the radiance distribution of the display device (without the protection film) of FIG. 17A and the radiance distribution of the display device (with the protection film) of FIG. 19A. This represents that the display device (with the protection film) of FIG. 19A has optical characteristics similar to those of the display device (without the protection film) of FIG. 17A because the adhesive layer 170 is almost not embedded into the plurality of light-emitting patterns 150 of the light-emitting member 100.

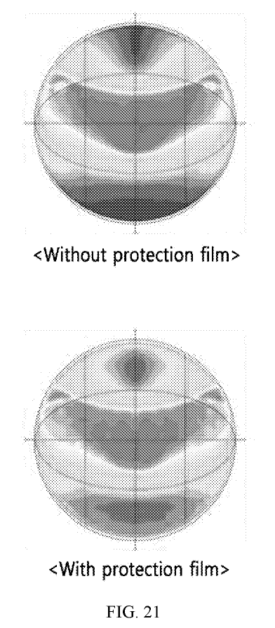

FIG. 21 is a radiance distribution view of the display device (without the protection film) of FIG. 17B and the display device (with the protection film) of FIG. 19B.

Referring to FIG. 21, it may be known that there is almost no difference between the radiance distribution of the display device (without the protection film) of FIG. 17B and the radiance distribution of the display device (with the protection film) of FIG. 19B. This represents that the display device (with the protection film) of FIG. 19B has optical characteristics similar to those of the display device (without the protection film) of FIG. 17B because the adhesive layer 270 is almost not embedded into the plurality of light-emitting patterns 250 of the light-emitting member 200.

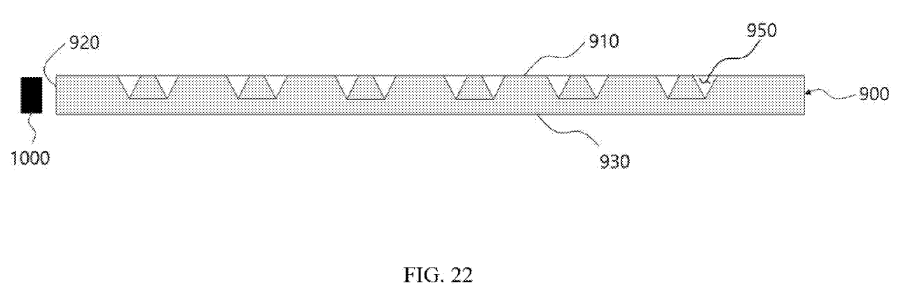

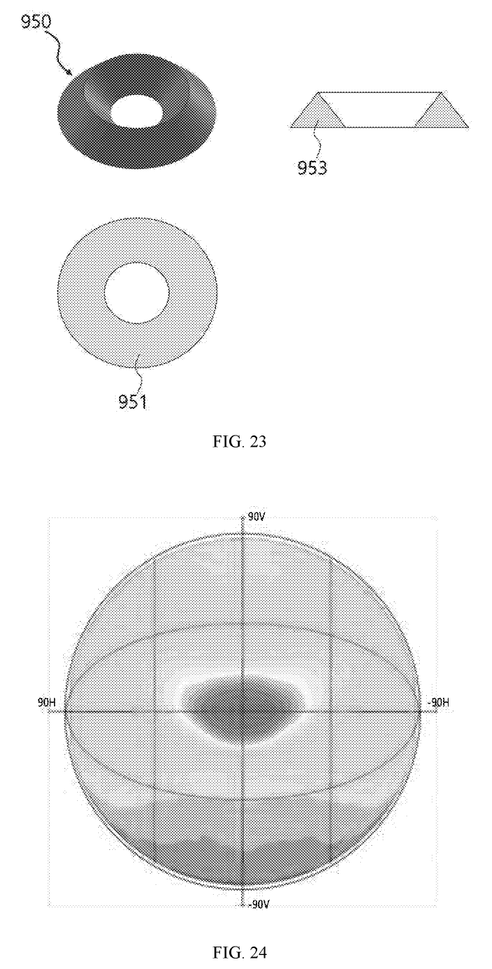

FIG. 22 is a cross-sectional view illustrating a light-emitting member 900 according to another embodiment of the present disclosure, and FIG. 23 is a view for explaining a perspective view, a bottom surface shape, and a cross-sectional shape of only the light-emitting pattern 950 illustrated in FIG. 22.

Referring to FIGS. 22 and 23, the light-emitting member 900 according to another embodiment of the present disclosure has a plate shape having a predetermined thickness.

The light-emitting member 900 may be made of a light-transmissive material.

The light-emitting member 900 may be made of a rigid material or a flexible material. For example, the light-emitting member 900 may be made of a resin or PMMA.

The light-emitting member 900 has one surface 910 (or a patterned surface). A plurality of light-emitting patterns 950 are defined in the one surface 910.

The light-emitting member 900 has the other surface 930 (or a light-emitting surface). Light reflected by the light-emitting patterns 950 is emitted to the outside through the other surface 930.

The light-emitting member 900 has a plurality of side surfaces disposed between the one surface 910 and the other surface 930. One side surface 920 of the plurality of side surfaces serves as an incidence surface to which light emitted from a light source 1000 is incident.

The light-emitting pattern 950 has a bottom surface 951 having a circular donut shape.

The light-emitting pattern 950 has a cross-section 953 having an isosceles triangular shape. More particularly, the cross-section 953 has a shape in which two isosceles triangles are spaced a predetermined distance from each other. Here, the cross-section 953 is obtained by cutting the light-emitting pattern 950 perpendicularly to the one surface 910 along a line passing through a center of the bottom surface 951.

FIG. 24 is a radiance distribution view of the display device having the light-emitting member 900 illustrated in FIGS. 22 and 23.

Referring to FIG. 24, it may be known that the display device having the light-emitting member 900 in FIGS. 22 and 23 efficiently converges light toward a center thereof. Also, the display device having the light-emitting member 900 may further include a protection film (not shown) laminated onto one surface 910 of the light-emitting member 900 as illustrated in FIGS. 19A and 19B. Since the bottom surface 951 of the light-emitting pattern 950 has a circular donut shape, it is difficult for the adhesive layer of the protection film (not shown) to be embedded into the light-emitting pattern 950. Thus, as described above with reference to FIG. 2, the conventional problem in which the adhesive layer is embedded into the light-emitting pattern to prevent light from being emitted from the light-emitting surface may be solved.

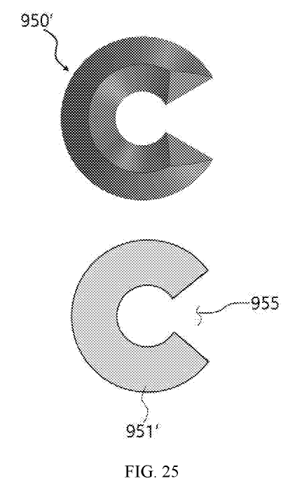

FIG. 25 is a view for explaining a perspective view and a bottom surface shape of a modified example of the light-emitting pattern 950 illustrated in FIG. 23.

A light-emitting pattern 950' according to the modified example in FIG. 25 is the same as the light-emitting pattern 950 in FIG. 23 in that a bottom surface 951' has a circular donut shape, but is different in that an opening 955 is formed in a portion of a bottom surface 951'. Due to the opening 955, an overall shape of the light-emitting pattern 950' is different from that of the light-emitting pattern 950 in FIG. 23. The opening 955 provides an air path through which air is easily discharged when a plurality of light-emitting patterns 950' are formed on the light-emitting member by an imprinting method.

Since the light-emitting pattern 950' according to the modified example in FIG. 25 also has the bottom surface 951' having the circular donut-shape, there is an advantage in that an adhesive layer of a protection film (not shown) is difficult to be embedded into the light-emitting pattern.

The protection film (not shown) may be further disposed on one surface of the light-emitting member having the light-emitting pattern 950' according to the modified example in FIG. 25.

According to the embodiment of the present disclosure, when the light-emitting member and the display device including the same are used, there is an advantage in that the vertical light-emitting characteristics may be improved.

Also, there is an advantage in that the searchlight phenomenon may be improved.

Also, there is an advantage in that the adhesive layer of the protection film is not embedded into the light-emitting patterns.

Although embodiments have been described with reference to a number of illustrative embodiments thereof, it should be understood that numerous other modifications and embodiments may be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A light-emitting member comprising:
one side surface;
one surface on which a plurality of light-emitting patterns are formed; and
the other surface through which light reflected and/or refracted by the plurality of light-emitting patterns is emitted,
wherein each of the light-emitting patterns is a concave pattern corresponding to a portion of a cone having a bottom surface and a predetermined depth,
the bottom surface of the light-emitting pattern has a fan shape,
the bottom surface of the light-emitting pattern has a central angle equal to or greater than 90° and less than 360°,
a cross-section of the light-emitting pattern has a right triangular shape,
the cross-section is a surface obtained by cutting the light-emitting pattern perpendicularly to the one surface along a line passing through a center of the bottom surface, and
an arc portion of the bottom surface of the light-emitting pattern is disposed to face the one side surface.

2. The light-emitting member of claim 1, wherein a radius of the bottom surface is less than the depth.

3. The light-emitting member of claim 1, further comprising a protection film disposed on the one surface and having an adhesive layer.

4. A light-emitting member comprising:
one side surface;
one surface on which a plurality of light-emitting patterns are formed; and
the other surface through which light reflected and/or refracted by the plurality of light-emitting patterns is emitted,
wherein each of the light-emitting patterns is a concave pattern having a bottom surface having a circular donut shape,
a cross-section of the light-emitting pattern has an isosceles triangular shape,
the cross-section is a surface obtained by cutting the light-emitting pattern perpendicularly to the one surface along a line passing through a center of the bottom surface, and
the isosceles triangular shape has a base side contained in the bottom surface and one vertex disposed in a direction from the one surface to the other surface.

5. The light-emitting member of claim 4, wherein the cross-section comprises two isosceles triangles spaced apart from each other.

6. The light-emitting member of claim 4, wherein the bottom surface of the light-emitting pattern has an opening defined in a portion thereof.

7. A display device comprising:
the light-emitting member of claim 1; and
a light source configured to provide light to at least one side surface of the light-emitting member.

8. The display device of claim 7, wherein a diffusion sheet and a prism sheet are configured so as not to be disposed on the light-emitting member.

9. A display device comprising:
the light-emitting member of claim 4; and
a light source configured to provide light to at least one side surface of the light-emitting member.

10. The display device of claim 9, wherein a diffusion sheet and a prism sheet are configured so as not to be disposed on the light-emitting member.

11. A display device comprising:
the light-emitting member of claim 1;
a light guide member disposed on the light-emitting member; and
a light source configured to provide light to at least one side surface of the light guide member.

12. The display device of claim 11, wherein a diffusion sheet and a prism sheet are configured so as not to be disposed on the light-emitting member.

13. A display device comprising:
the light-emitting member of claim 4;
a light guide member disposed on the light-emitting member; and
a light source configured to provide light to at least one side surface of the light guide member.

14. The display device of claim 13, wherein a diffusion sheet and a prism sheet are configured so as not to be disposed on the light-emitting member.
